(19) United States
(12) Patent Application Publication
(10) Pub. No.: US 2018/0041038 A1
(43) Pub. Date: Feb. 8, 2018

(54) HYBRID POWER GENERATION STATION

(71) Applicant: HONG DENG, Hayward, CA (US)

(72) Inventor: HONG DENG, Hayward, CA (US)

(21) Appl. No.: 15/228,779

(22) Filed: Aug. 4, 2016

(51) Int. Cl. H02J 3/38; H02K 7/18

(52) U.S. Cl. CPC H02J 3/38; H02J 3/383; H02J 3/386; H02K 7/1823

(57) ABSTRACT

The present invention is a hybrid wind and solar power generator. The system uses a concentrated sun light and diluted sun light to increase the efficiency of the whole system. The combination of solar and wind power generators decreases the cost of common elements for generating electricity.

### FIELD OF THE INVENTION

The present invention relates in general to hybrid renewable power generation and in specific to combining solar and wind systems.

### BACKGROUND OF THE INVENTION

Solar and wind energy have incredible potential for electricity production. Over the years, industries have made several attempts to harvest wind and solar energy with high efficiency.

Concentrated Solar Power (CSP) energy systems convert sunlight into electricity using parabolic mirrors. The concentrated solar energy is either focused on a photovoltaic module, or a heat receiver that absorbs the solar energy and transfers it to a working fluid such as a high temperature oil, molten salt, or hydrogen.

The most widely used CSP technology utilizes a large number of parabolic trough having parabolic mirrors with a common focal point. The troughs are arranged in a large space and usually in a number of rows. A receiver pipe at the focal point of the parabolic troughs absorbs the concentrated solar energy. Power towers are another CSP technology that could become more economical than parabolic troughs by using a field of mirrors to focus on a central receiver that boils water for a standard steam cycle.

Thermal storage can be used in these systems to provide electricity during peak hours or when the sun intensity is low. The storage tanks can use molten salts for indirect heat exchange systems. The molten salt storage tanks offer an inexpensive means of storing solar energy in comparison to other storage media such as batteries with higher lifetime and efficiency.

High concentrating photovoltaics (HCPV) have recently become the most energy efficient technology to convert solar energy into electricity. HCPV systems employ concentrating optics consisting of dish reflectors or Fresnel lenses that concentrate sunlight to intensities of 1,000 suns or more. The multi junction solar cells require high-capacity active cooling system to prevent thermal destruction and to manage temperature related electrical performance and life expectancy losses.

The current technologies have several drawback: Sun energy is diluted; large scaled photovoltaic (PV) plants require large land usage due to their low efficiency, therefore, the cost of collecting system is increasing with the increased scale.

The wind and solar outputs are intermittent and uncontrollable, if no storage exists.

The CSP technologies, such as parabolic trough and power tower, have low converting rate and high cost, and do not work with diffused light. Silicon cells cannot absorb all sun spectrums, and therefore, their efficiency is low. The uncollected spectrums are converted to heat radiation and are wasted.

Concentrated photovoltaic has higher efficiency but also higher cost due to the active cooling and two-axes tracking system. The thermal generated by cooling system cannot be easily converted to electricity because HCPV cell require low temperature to have the best performance. However, the cost can be lowered by increasing the scale. Also increasing the aperture size will increase the amount of solar radiation intercepted by the receiver, but also will increase the losses due to convection and radiation out of the aperture. Convection and radiation decrease the effective radiative energy absorbed in the receiver.

Despite these limitations, combination of wind and solar energy can be a perfect match, since normally when the sun is shining there is little wind, and at night time and cloudy days there is more wind.

With a proper storage, the wind-solar combined system can provide continuous power output to meet the fluctuation in the load demand. The system can be easily built in large scales with less land, e.g. one wind tower can be 5-8 MW and the solar energy can be 1 kW/m². The efficiency of the solar energy converted to electricity can be above 70% with storage, since the invisible spectrum of the sun light is used to generate heat and be stored in a molten salt heat storage. The cooling water of the HCPV solar cell can be used as preheated water, which is heated up later by molten salt for steam turbine. In the existing photovoltaic conversion systems, the heat is normally wasted.

### SUMMARY OF THE INVENTION

The present invention is a combination of wind and solar energy to achieve higher efficiencies, larger scale and controllable power output with lower cost. The system basically comprises of three portions.
1. Wind turbine integrated with centralized HCPV receivers system mounted on the tower;
2. Fixed focus dish solar concentrator with solar spectra splitting technology for both photovoltaic (visible light) and thermal storage (invisible light); and
3. Molten salt thermal storage and conventional steam generator.

The system utilizes a plurality of parabolic mirrored solar receptors which focus solar energy into a lens, which lens focuses visible spectrum light to a aiming mirror for aiming at a central wind tower, and which reflects the rest of spectrum light to a receptor for heating molten salt. Molten salt is also heated by PV cell installed at the back of the parabolic mirror from catching the diffused light. The visible light which is reflected by the aiming mirror is aimed at a receptor on the tower of a wind turbine, which receptor is also for high concentrated photovoltaic with heating cooling water. In return, the heated water (around 90 degree) from the cooling system can later be further heated up by the stored molten salt and utilized for electrical generation through standard techniques.

Since the visible light is redirected to a wind tower for HCPV cells to generate electricity so that the cost on collecting the electricity is minimized. In addition, other equipment, such as inverter step up transformer, cooling systems can also be minimized through this centralized arrangement.

Fixed focus solar dish collector is used to collect the direct sunlight radiation, an optical means with IR reflection on one side is used to split the spectrum to allow the visible light passing through the optical means and form a parallel incident light while the other spectrum reflecting back to the center of the dish. Visible light can then be re-directed and aim to the HCPV receivers on wind tower for photovoltaic, and the rest are used for thermal storage through conventional CSP technology. The back side of the dish has enough space to install thin film solar cells to catch the diffused light for thermal storage. This may further increase the efficiency of the sunlight use.

The parallel incident light will be redirected to the aiming mirror mounted 6 meter above the focal point by a stretchable mirror, when dish moves to track the sun, the mirror will also change the length and angle to reflect all the light to aiming mirror.

The present invention can be used for expansion of the existing wind farms by adding solar collecting yard, thermal storage and steam turbine or retiring the existing end of life fossil fuel generation stations by keeping the conventional portion and adding the renewable portion. The present invention is a centralized renewable hybrid power generation technology matches the need of the existing bulk grid and transmission system.

### BRIEF DESCRIPTION OF THE DRAWINGS

Embodiments herein will hereinafter be described in conjunction with the appended drawings provided to illustrate and not to limit the scope of the claims, wherein like designations denote like elements, and in which:

FIG. 1 shows a schematic diagram of an embodiment of the present invention;

FIG. 2 shows a perspective view of a solar dish collector of the present invention;

FIG. 3 shows a side view of a solar dish collector of the present invention;

FIG. 4A shows a perspective view of an optical means of the present invention;

FIG. 4B shows a side view of an optical means of the present invention;

FIG. 4C shows a side view of an optical means of the present invention;

FIG. 5A shows a perspective view of a light reflector of the present invention;

FIG. 5B shows a side view of a light reflector of the present invention;

FIG. 6A shows a top view of the light reflector with the bearing system;

FIG. 6B shows a side view of the light reflector with the bearing system;

FIG. 7 shows a wind turbine and a plurality of HCPV receiver installed at wind tower; and

FIG. 8 shows a wind turbine and a plurality of solar dish collectors of the present invention.

### DETAILED DESCRIPTION OF PREFERRED EMBODIMENTS

The figures are not intended to be exhaustive or to limit the present invention to the precise form disclosed. It should be understood that the invention can be practiced with modification and alteration, and that the disclosed technology be limited only by the claims and equivalents thereof.

The technology disclosed herein, in accordance with one or more various embodiments, is described in detail with reference to the following figures. The drawings are provided for purposes of illustration only and merely depict typical or example embodiments of the disclosed technology. These drawings are provided to facilitate the reader's understanding of the disclosed technology and shall not be considered limiting of the breadth, scope, or applicability thereof. It should be noted that for clarity and ease of illustration these drawings are not necessarily made to scale.

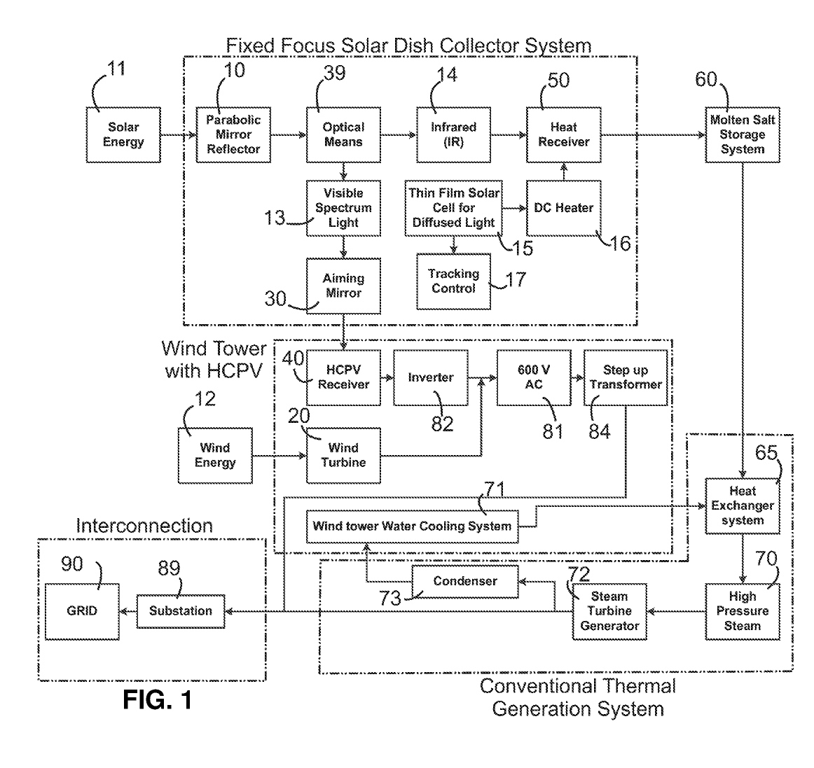

The schematic concept of the present invention is shown in FIG. 1. The combination of harvesting solar energy 11 and wind energy 12 with present parabolic mirror reflector 10 and wind turbine 20 with the necessary elements are shown in FIG. 1. Solar energy 11 is collected by a parabolic mirror reflector 10, which has an optical means 39 to concentrate visible spectrum light 13 and reflect the rest of the spectrum light e.g. infrared energy 14. The reflected infrared energy is captured by a receptor e.g. heat receiver 50 in the back portion of the parabolic mirror reflector 10 to be used to heat cold molten salt 60. The concentrated visible light 13 is reflected to high concentrated photovoltaic HCPV receiver 40 by an aiming mirror 30. The diffused light collect by the thin film solar cells 15 designed at the back portion of the parabolic mirror reflector 10. The electricity produces from the cheat solar cells used for tracking control system 17 and the DC heater 16 to heat up the molten salt in the molten salt storage system 60.

Again as shown in FIG. 1, a water cooling system 71 for heat removal for wind turbine 20 and HCPV receiver on wind tower 40 are combined in the present invention to decrease the cost for having two separate cooling systems for the HCPV receivers and wind turbine.

Again as shown in FIG. 1, the infrared energy 14, captured by a heat receiver 50 installed in the solar dish collector 10 provides the necessary energy to heat a molten salt reservoir 60. To increase the efficiency, a storage tanks is used to store the molten salts 60 for indirect heat exchanger system 65. The molten salt 60 storage tank offers an inexpensive means of storing solar energy in comparison to other storage media, such as batteries. In addition, the molten salt 60 has a higher lifetime and efficiency compared to batteries.

As shown in FIG. 1, the molten salt 60 can be used to provide heat for heat exchanger system 65 to generate high pressure steam 70 for steam turbine generator 72 to produce electricity. The used steam in the proposed system will return to the condenser 73 and to the wind tower water cooling system 71.

By combining the solar energy 11 and wind energy 12 in the present embodiment, the components, such as DC to AC inverter 82, step up transformers 84, for transferring electricity to the substation 89 and the grid 90, can be used for both systems to decrease the cost.

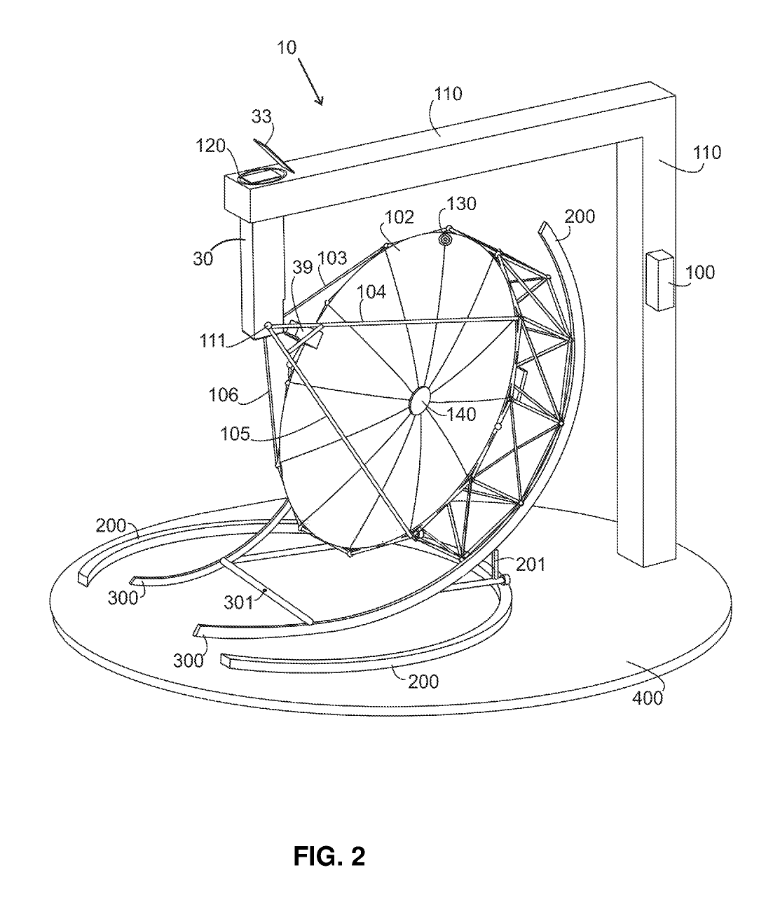

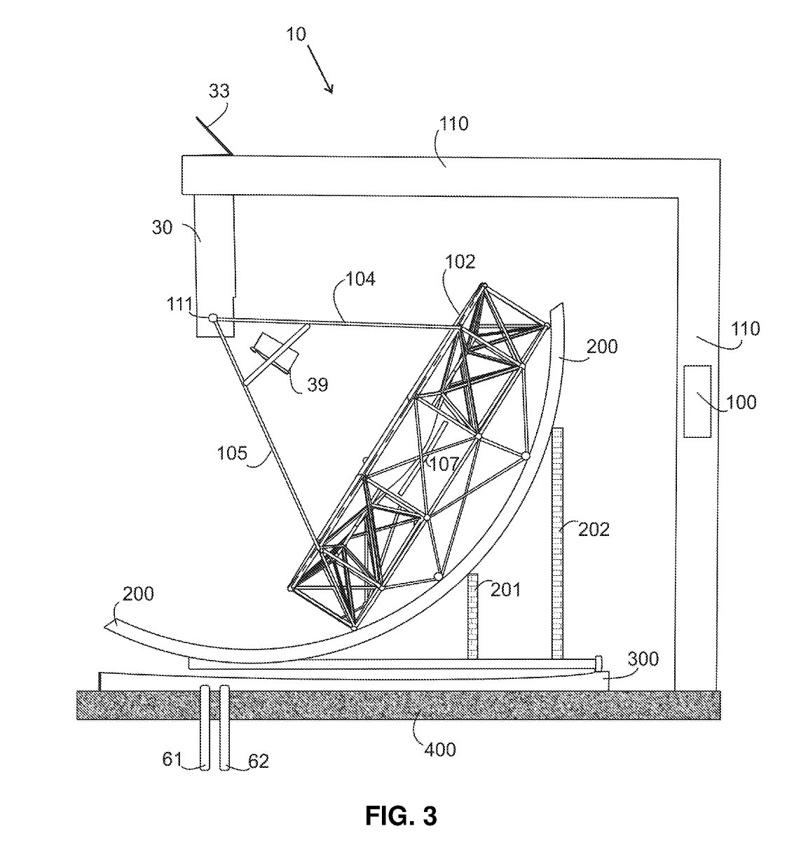

One embodiment of a solar dish collector 10 of the present invention is shown in FIGS. 2-3. The solar dish collector 10 comprises of a parabolic surface 102, a plurality of support bracing 103-106 to hold an optical means 39 and also pivotally attach to an aiming mirror 30. The solar dish collector further has a support base 110 to support whole structure and the aiming mirror 30. Again as shown in FIG. 2, the parabolic surface 102 comprises of a plurality of mirrors which are attached to the surface 102 to collect and concentrate the sun light.

As shown in FIGS. 2-3, the front portion of the parabolic surface 102 is covered by a plurality of mirrors. At the back portion of the parabolic surface 102, a heat receiver 107 locates to absorb heat from the diffused light. The diffused light passes through an opening 140 at the centre of the parabolic surface 102 and hits the heat receiver 107. The heat receiver 107 is fixed to the back portion of the parabolic surface 102.

Two flexible ducts carry a molten salt to the heat receiver 107 and to the two fixed ducts at the bottom portion of the solar dish collector. The fixed ducts are responsible for carrying molten salt in the molten salt storage system. A cheat photovoltaic cell can be replaced at the back portion of the parabolic surface 102 to generate electricity. The electricity which produced from the thin film solar cell can be used for a DC heater to heat the molten salt and also provide electricity for the tracking system.

The heat absorbs by heat receiver 107 is collected by a molten salt circulation system, which is installed at the back portion of the dish 10. As shown in FIGS. 2-3, a piping system 61-62 circulates the molten salt in the proposed system, as an indirect heat exchanger system. The fixed ducts 61-62 are located at the bottom portion of the solar dish collector 10, two flexible ducts connect to the fixed ducts 61-62 and the heat receiver 107. Flexible ducts are used in the proposed system, because the solar dish collector is moving and tracking the sun light during a day time.

Again as shown in FIGS. 2-3, during a day, the solar dish collector 10 traces the sun movement. For tracking sun movement, the solar dish collector 10 moves by the support bracings 103-106 over a railing system 200 at the back portion. The railing system 200 supports the dish in a specific position, the movement of the solar dish collector 10 over the railing system 200 drives by a mechanical motor (not shown). The railing system supports by a plurality of pillars 201-202 over the ground 400. For the horizontal movement, a circular rail 300 is used, the circular rail provides the horizontal movement for the whole structure, the circular railing rotates around the bearing point 301. The solar dish collector 10 and the aiming mirror 30 rotate over the bearing point 301. The solar dish collector 10 also rotates over a pivot point 111 which is located at a distal end of the aiming mirror 30.

At least one light direction sensor 130 is installed in the parabolic surface 102 to detect sun light direction and move the solar dish collector 10 with bearing system 120 and the support bracing systems 103-106 over the pivot point 111. The solar dish collector 10 is designed to follow the sun, and its direction is changed to collect the sun light when the light direction is changed.

A control system 100 controls the light direction sensor 130, the bearing system 120 and the movement of support bracing system 103-106 over the pivot point 111 and the railing system 200. The purpose of the control system 100 is to track the sun light during a day time to make sure the visible spectrum light reflects to the wind tower.

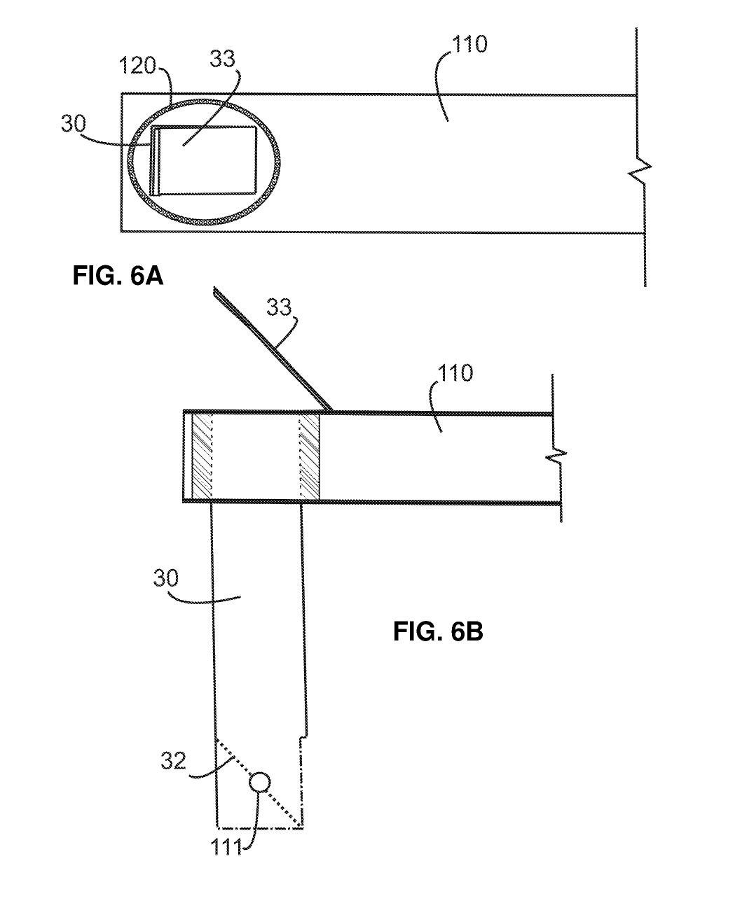

As shown in FIGS. 2, 6A and 6B, the aiming mirror 30 has a bearing system 120. The bearing system 120 is designed at a distal end of the support base 110. The bearing system 120 rotates the aiming mirror 30 by the rotation of the solar dish collector 10. When the solar dish collector 10 rotates over the circular railing 300, the aiming mirror 30 also rotates by the bearing system 120.

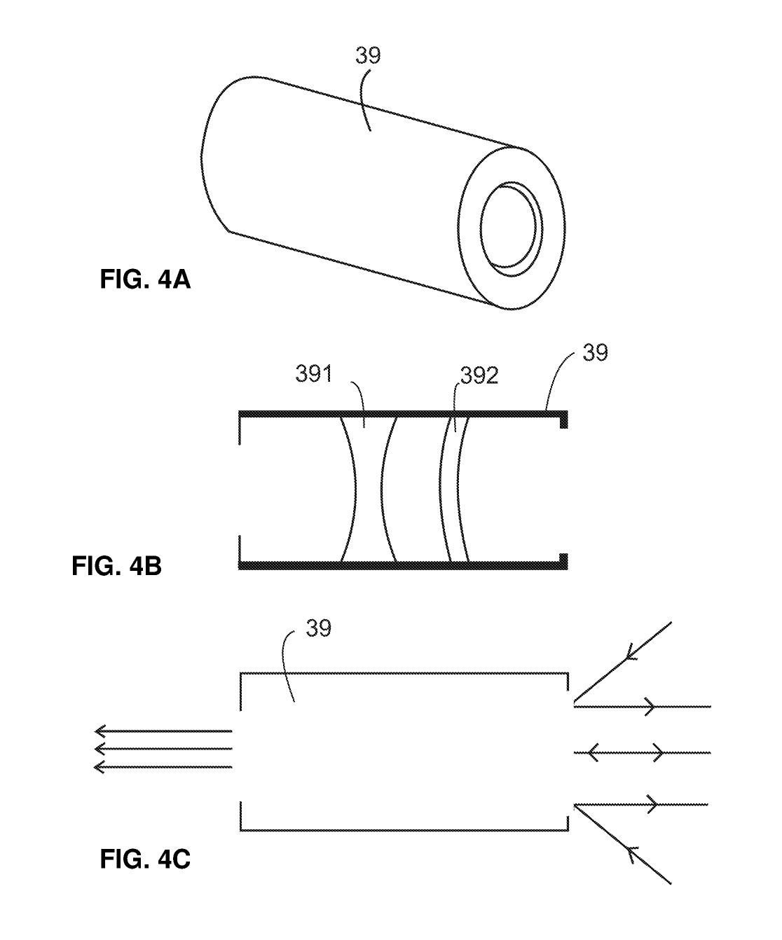

The optical means 39 of the present invention is shown in FIGS. 4A, 4B and 4C. The optical means 39 is designed to concentrate the visible spectrum light and reflect the rest of the spectrum (Infrared). The optical means 39 comprises of a plurality of lenses 391-392. Any combination of concave lenses and convex lenses is possible to concentrate some portion of sun light and reflect the inferred. In the FIG. 4B, one example for the present invention is shown. The optical means 39 which is connected to the support bracing and the pivot point on the light reflector is located in the focal point in all time to concentrate and reflect the sun light.

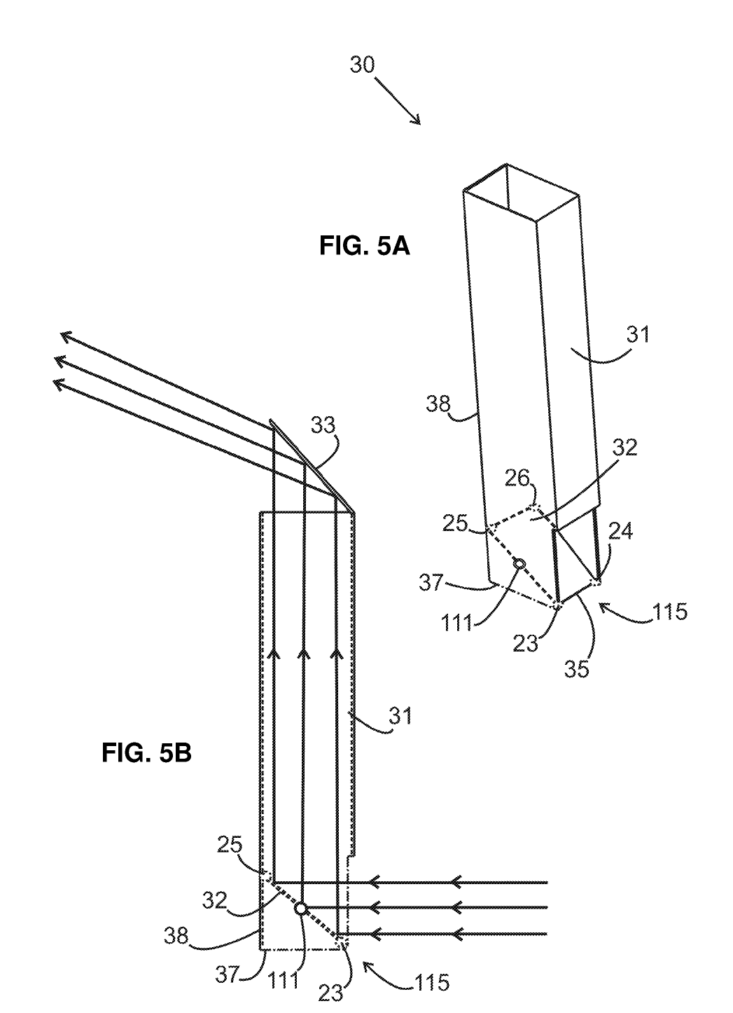

The aiming mirror 30 of the present invention is shown in FIGS. 5A, 5B, 6A, 6B, 7A, 7B and 7C. The aiming mirror 30 comprises of a reflector-body 31 and a reflecting mirror 32. The first reflecting mirror 32 has a moving means 23-26 to move a distal end 35 of the first reflecting mirror 32 on a horizontal surface 37 and a proximal end 36 on a vertical surface 38. The moving means for the first reflecting mirror 32 have a plurality of rollers 23-26 on the edges. When the distal end 35 of the first reflecting mirror 32 moves back on the horizontal surface 37, the proximal end 36 moves up on the vertical surface 38. The reflector-body 31 has an L-shaped opening 115 in a distal end near the first reflecting mirror 32. The first reflecting mirror 32 stretches over the opening 115.

The control system 100 of the present invention controls the movement of the rollers 23-26 for the first reflecting mirror 32 and the dish movement to make sure that the sun light is efficiently captured and reflected to the wind tower.

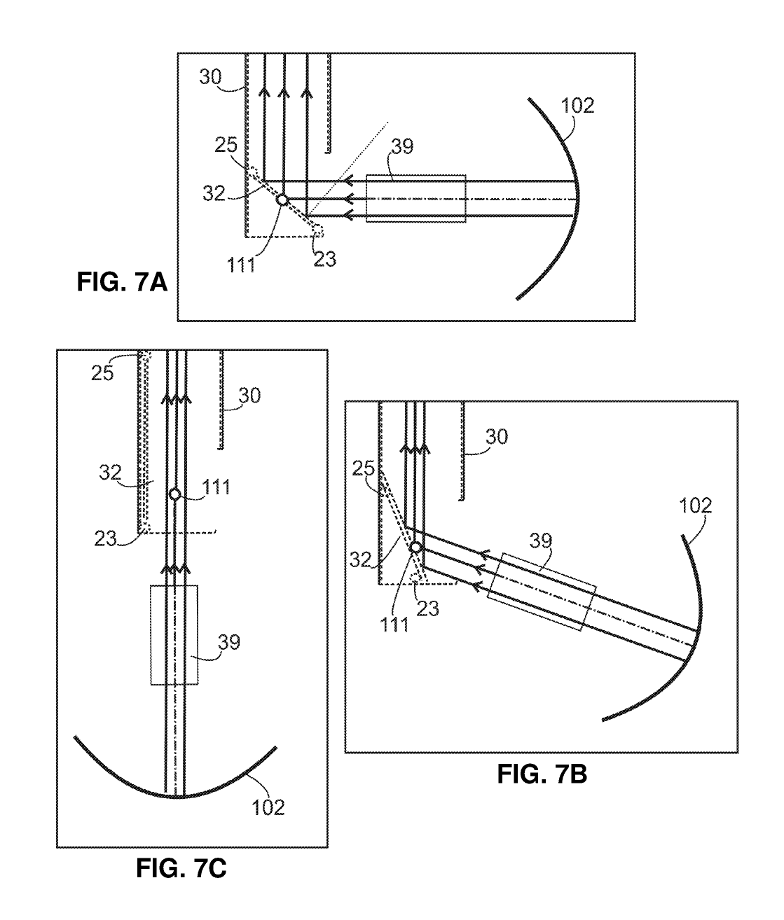

Again as shown in FIGS. 7A, 7B and 7C, the location of the optical means 39 is fixed by the movement of the parabolic surface 102. The first reflecting mirror 32 moves by the rotation of the parabolic surface 102. The rollers 23-26 help the first reflecting mirror 32 to stretch. The control system 100 controls the movement of the first reflecting mirror 32 and the parabolic surface 102. The control system makes sure the reflecting light will pass through the second reflecting mirror installed at the top portion of the support base 110.

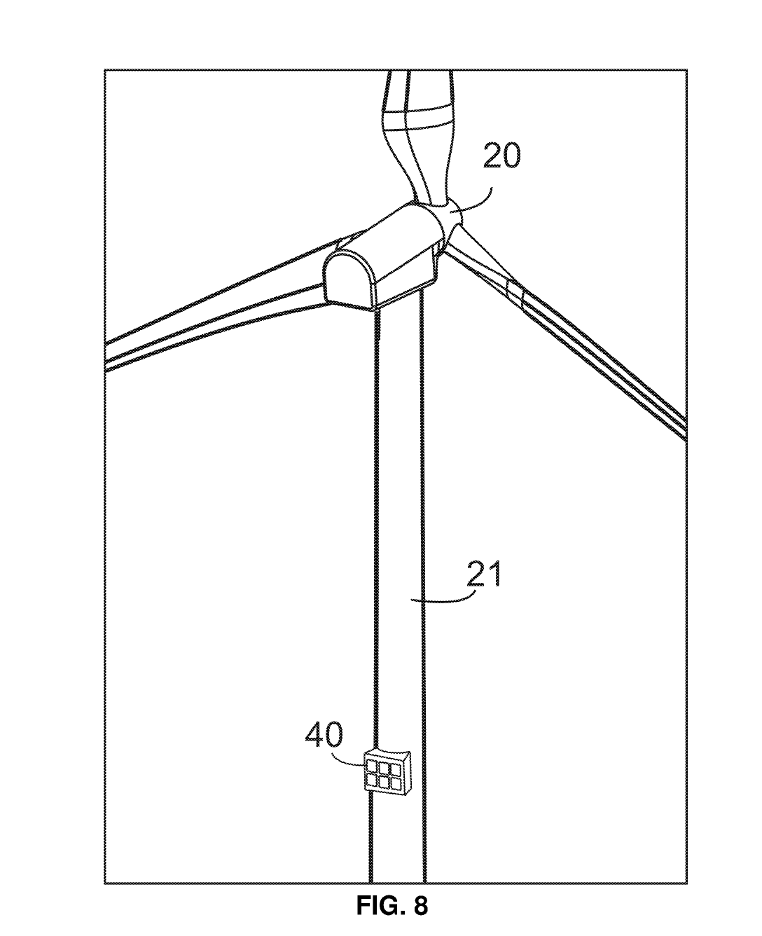

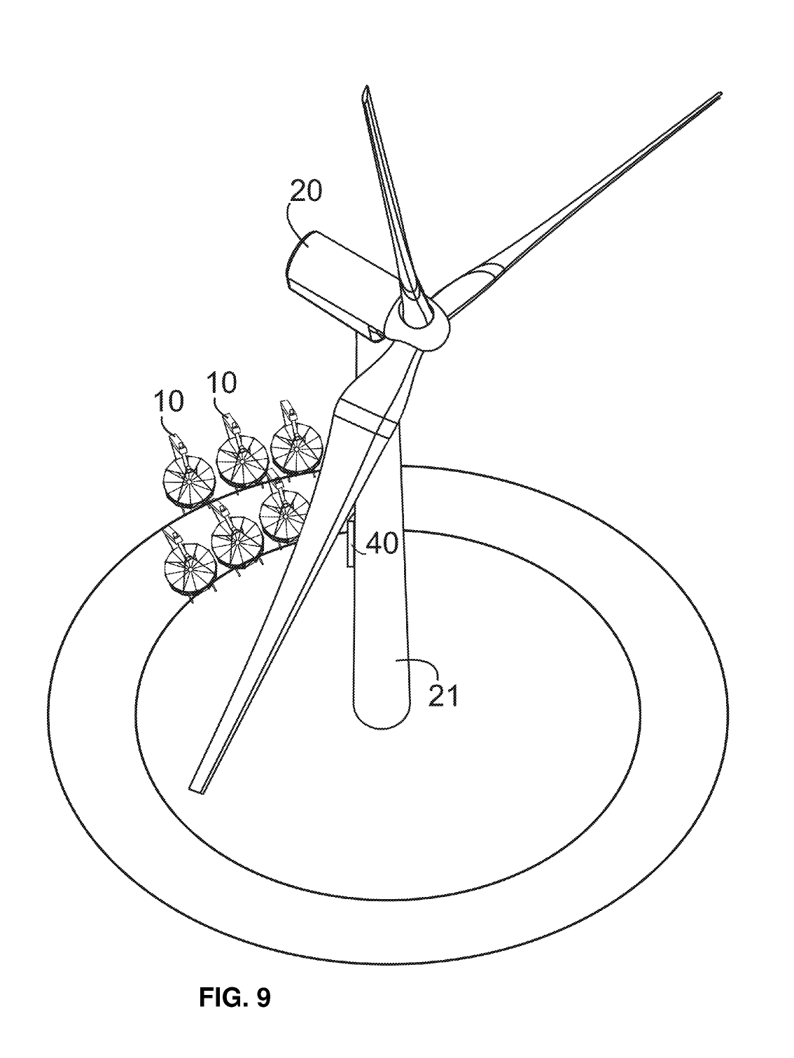

FIGS. 8 and 9 show a wind turbine 20, which has a plurality of HCPV receivers 40. The HCPV 40 has multi-junction solar cells that absorb the sun light and produce electricity. The cooling system for the wind turbine 20 and the HCPV receivers 40 are combined to achieve economical solution for both systems. The HCPV receivers 40 are installed on the tower body 21 along its lengths.

Again as shown in FIG. 9, a plurality of solar dish collectors 10 is arranged in circular arrangement to harvest the sun light and reflect it to the wind tower 21. Each HCPV receiver 40 is assigned for one dollar dish collector 10. The combination of solar energy and wind energy of the present invention can be applied in new power plants or existing wind farms or solar farms to decrease the cost of installing common equipment for both systems.

The foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

With respect to the above description, it is to be realized that the optimum relationships for the parts of the invention in regard to size, shape, form, materials, function and manner of operation, assembly and use are deemed readily apparent and obvious to those skilled in the art, and all equivalent relationships to those illustrated in the drawings and described in the specification are intended to be encompassed by the present invention.

What is claimed is:

1. A hybrid wind and solar power generator comprising:
a. a solar dish collector comprising of:
i. a base and a stand;
ii. a parabolic surface having a front portion and a back portion, wherein said front portion having a plurality of mirrors to capture and concentrate sun light;
iii. a vertical railing system, wherein said solar dish collector rotates over said vertical railing system;
iv. a horizontal railing system, wherein said solar dish collector rotates over said horizontal railing system;
v. an optical means to receive and concentrate sun light and to reflect infrared energy to a heat receiver;
vi. an aiming mirror to reflect concentrate light to a high-concentrated photovoltaic (HCPV) receiver, wherein said aiming mirror has a means to adjust a mirror;
vii. a bearing system to rotate said aiming mirror;
viii. a support bracing system to pivotally connect said solar dish collector to said aiming mirror;
ix. a heat receiver at said back portion sized to receive said infrared energy, wherein said heat receiver heats a cold molten salt fluid and makes a hot molten salt fluid;
x. a control system having an adjusting means to adjust and align said parabolic surface during a day time to face to the sun as the sun moves relative to the position of said solar dish collector;
b. a wind turbine having a wind tower with a plurality of said HCPV installed on said wind tower, said wind turbine converts mechanical energy to an electricity;
c. a molten salt storage system to circulate said cold molten salt and hot molten salt, and
d. a steam turbine generator to use said molten salt storage system to generate electricity.

2. The hybrid power generator of claim 1, wherein said aiming mirror comprises of:
a. a body;
b. a first reflecting mirror to reflect said concentrated light;
c. a plurality of rollers installed at the edges of said first reflecting mirror to adjust said first reflecting mirror during a day, and
d. said control system control said rollers during a day time to make sure the reflected light received by said HCPV receivers.

3. The hybrid power generator of claim 1, wherein said aiming mirror rotates at a distal end of said base.

4. The hybrid power generator of claim 1, wherein said solar dish collector rotates around a pivot point at a distal end of said aiming mirror.

5. The hybrid power generator of claim 1, wherein said wind turbine further has a water cooling system, whereby said water cooling system cools said wind turbine and said HCPV receiver.

6. The hybrid power generator of claim 1, wherein said solar dish collector further has a plurality of light direction sensors to track the sun and face said parabolic surface to the sun as the sun moves.

7. The hybrid power generator of claim 1, wherein said means to adjust a mirror comprising of a plurality of rollers installed at each edge of said mirror to moves a first end of said mirror horizontally and a second end of said mirror vertically.

8. The hybrid power generator of claim 1, wherein said heat receiver comprises of a plurality of solar cells installed at a back portion of said parabolic surface.

9. The hybrid power generator of claim 1, wherein said optical means comprises of a plurality of concave and convex lenses.

10. The hybrid power generator of claim 1, wherein said solar dish collector moves over said vertical railing system and horizontal railing system by a motor.

11. The hybrid power generator of claim 1, wherein said optical means is located at a focal length of said parabolic surface.

12. The hybrid power generator of claim 1, wherein said support bracing system pivotally connects to said aiming mirror.

13. The hybrid power generator of claim 1, wherein said parabolic surface further having an opening.

14. The hybrid power generator of claim 1, wherein said heat receiver further having two flexible ducts to carry said molten salt.
